(19) United States
(12) Patent Application Publication
(10) Pub. No.: US 2007/0016398 A1
(43) Pub. Date: Jan. 18, 2007

(54) Parsing method

(75) Inventor: Sabine Buchholz, Cambridge (GB)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/485,299

(22) Filed: Jul. 13, 2006

(30) Foreign Application Priority Data
Jul. 15, 2005 (GB) 0514601.4

(51) Int. Cl. G06F 17/28

(52) U.S. Cl. 704/4

(57) ABSTRACT

A method of parsing natural language comprising the steps of: a) receiving a tokenised and part-of-speech tagged utterance comprising n tokens b) for the first token; i) calculating a partial parse consisting of one dependency relation by assigning a role and a head for the first token; ii) calculating the probability of the partial parse from step (i) iii) repeating steps (b)(i) and (b)(ii) for all possible heads and roles of the token and storing the A most likely resulting partial parses c) advancing to the next successive token and, for each of the A partial parses from the previous step: iv) calculating a possible next extension to the partial parse by one dependency relation v) calculating the probability of the extended partial parse from (c)(i) vi) repeating steps (c)(i) and (c)(ii) for all possible heads and roles of the token and storing the A most likely resulting partial parses d) repeating step (c) for each successive token until all n tokens have been parsed.

### FIELD OF THE INVENTION

The present invention relates to language processing and in particular, the present invention relates to syntactic parsing of text.

### BACKGROUND OF THE INVENTION

A language parser is a program that takes a text segment, usually a sentence of natural language (i.e., human language, such as English) and produces a representation of the syntactic structures in the sentence.

Before parsing takes place a sentence of a natural language is usually resolved into its component parts in a process called tokenisation. The act of parsing the sentence comprises determining the structural relationships amongst the words from which the sentence is constructed. There are at least two approaches to representing these structural relationships: the constituent structure approach and the dependency structure approach.

In the constituent structure approach (also alternatively referred to as the phrase structure approach) the fundamental idea is that words group together to form so-called constituents/phrases i.e. groups of words or phrases which behave as a single unit. These constituents can combine together to form bigger constituents and eventually sentences. So for instance, “John”, “the man”, “the man with a hat” and “almost every man” are constituents (called Noun Phrases or NP for short) because they all can appear in the same syntactic context (they can all function as the subject or the object of a verb for instance).

In the phrase structure approach, the structure of a sentence is represented by phrase structure trees. Such trees provide information about the sentences they represent by showing how the top-level category S (i.e. the sentence) is composed of various other syntactic categories (e.g. noun phrase, verb phrase, etc.) and how these in turn are composed of individual words.

The basic idea of the dependency approach is that the syntactic structure of a sentence is described in terms of binary relations (dependency relations) between pairs of words, a head (parent), and a dependent (child), respectively. These relations are usually represented by a dependency tree.

In dependency theory the child word “belongs to” (or “depends on”) the head word. Each word has only a single head and a dependency relation is not allowable if it leads to a cycle (i.e. if following the relationships between words in a dependency structure you return to the starting word then the relationship is not allowable).

FIG. 1 shows the syntactic structure of the sentence “The dogs sleep on the carpet” using the constituent and dependency approaches.

The phrase structure approach is represented in the phrase structure tree of FIG. 1a in which S=Sentence, VP=Verb Phrase, NP=Noun Phrase and PP=Prepositional Phrase.

The dependency structure approach is shown in FIG. 1b as a series of arrows depicting the binary relations between words. It is noted that in dependency trees arrows may point from the head to the children or from the children to the heads. We will use the latter convention throughout this document such that arrows ‘depart’ from a child and point to their head.

So, in FIG. 1b for example, “dogs” is the head word and “The” is the child. The roles of each relation are attached to each arrow (e.g. subject, object of preposition etc.). The “ROOT” pseudo-word effectively marks the end of the sentence.

In FIG. 1b none of the dependencies cross one another. This is an example of a projective dependency structure. If the dependencies cross this is referred to as a non-projective dependency structure. Allowing non-projective structures makes parsing computationally more complex. Such structures are rare in English but may be more common in other languages and so for a multi-language parser both projective and non-projective structures should be supported.

In language processing, a sentence, sequence or utterance to be parsed is first broken down into a series of “tokens”. A token is the smallest lexical unit that is understood to have some syntactic relevance within a language. For example, individual words and punctuation are tokens. However, short phrases (e.g. “New York”) may also be regarded as tokens.

Language parsers can be used in a variety of applications. For example, text-to-speech synthesis, machine translation, dialogue systems, handwriting recognition, spell checking etc.

A parser will generally be one component of a larger system, e.g. a parser may receive input from a lexical scanner and output to a semantic analyzer, and the choice of parser type varies from system to system. Indeed some applications use no parser at all.

Using no parser, a shallow parser or an unlabelled dependency parser provides little or no syntactic information for subsequent modules within a system which may have a detrimental effect on performance. Further types of parser are discussed below.

Non-probabilistic parsers either deterministically derive just one parse [see for example Nivre, Joakim and Mario Scholz. 2004. Deterministic Dependency Parsing of English Text. In Proceedings of COLING 2004, Geneva, Switzerland, pp. 64-70.], or all possible parses, without any indication which one should be preferred, which is not suitable for applications where the parser has to help in resolving ambiguities in text (e.g. OCR, handwriting or speech recognition).

In addition, non-probabilistic parsers are often rule-based [e.g. Tapanainen, Pasi and Timo Järvinen. 1997. “A non-projective dependency parser”. In Proceedings of the 5th Conference on Applied Natural Language Processing (ANLP'97), pp. 64-71. ACL, Washington, D.C.], which makes them time-consuming to construct and adapt. Chart-based parsers have a runtime of at least O(n³) (which means, if the number of tokens in an input to be parsed is n, then the runtime is of the order (O) of n³) and cannot derive non-projective dependency parses.

Chart-based parsers using bilexical probabilities (which increases performance) either have a runtime of O(n⁵) [see Collins, Michael. 1999. Head-Driven Statistical Models for Natural Language Parsing. Ph.D. thesis, University of Pennsylvania], or cannot exploit some linguistically relevant information [see Eisner, Jason. 2000. Bilexical grammars and their cubic-time parsing algorithms. In Harry Bunt and Anton Nijholt (eds.), Advances in Probabilistic and Other Parsing Technologies, pp. 29-62. Kluwer Academic Publishers, which cannot use information about the left children of a token when attaching that token to a head on the right].

A further chart based parser is shown in U.S. Pat. No. 6,332,118 [Yamabana, Kiyoshi. 2001. Chart parsing method and system for natural language sentences based on dependency grammars].

### SUMMARY OF THE INVENTION

It is therefore an object of the present invention to provide a parsing method which substantially overcomes or mitigates the above mentioned problems.

According to a first aspect the present invention provides a method of parsing language comprising the steps of:
a) receiving a tokenised and part-of-speech tagged language input comprising n tokens
b) for the first token;
   i) calculating a partial parse consisting of one dependency relation by assigning a role and a head for the first token;
   ii) calculating the probability of the partial parse from step (i)
   iii) repeating steps (b)(i) and (b)(ii) for all possible heads and roles of the token and storing the A most likely resulting partial parses
c) advancing to the next successive token and, for each of the A partial parses from the previous step:
   i) calculating a possible next extension to the partial parse by one dependency relation
   ii) calculating the probability of the extended partial parse from (c)(i)
   iii) repeating steps (c)(i) and (c)(ii) for all possible heads and roles of the token and storing the A most likely resulting partial parses
d) repeating step (c) for each successive token until all n tokens have been parsed.

The present invention provides a method of deriving dependency parses for any tokenized and part-of-speech tagged natural language sentence. In the invention a natural language sentence or utterance that has been tokenized and also part-of-speech tagged is input into the parser. See [Mikheev, Andrei. 2002. Periods, Capitalised Words, etc. Computational Linguistics, Vol. 28, Issue 3, pp. 289-318. MIT Press] for a description of a tokenizer. See [Ratnaparkhi, Adwait. 1998. Maximum entropy models for natural language ambiguity resolution. Ph.D. thesis, University of Pennsylvania] for a description of a good part-of-speech tagger. As those skilled in the art will understand, it might also be possible to integrate the tagging phase into the parser itself.

The method of the first aspect of the present invention determines the heads and grammatical roles of tokens in strict order from one end of the input sentence to the other. Although it is assumed in the discussions below that the language is written from left to right and that the first token is the leftmost token of the sentence and the last token is the rightmost token of the sentence the procedure does not hinge on this. In other words the present invention will function equally well if the first token parsed is actually the rightmost token of the input sentence, i.e. the invention will work “in reverse”.

As noted above the parsing method of the present invention determines heads and grammatical roles in strict order, i.e. in a first step the role of the first token is determined along with which token is the first token's head. In the second step the role and head of the second token is determined and so on until the last token has been determined.

To determine the head and role of a token, the parsing method first retrieves a list of possible roles for the token. In the simplest case, this is the full set of roles. In an alternative embodiment, there are different lists for words with different PoS tags.

These lists can either be produced by hand or derived from a parsed corpus, a so-called treebank by listing which PoS occur with which roles. See for example [Marcus, M., et al. 1993. Building a large annotated corpus of English: The Penn Treebank. Computational Linguistics, 19(2):313-330.] In another alternative embodiment, there is a different list for each possible word or each combination of a word and one of its possible PoS. Typically, these lists are derived from a treebank and some estimated list is used for words that do not occur in the treebank. In the case of the present invention it is not important how the lists were originally produced; what is important is that a list can be looked up in constant time in a pre-stored table.

For each of the possible roles of token i and each other token j such that a dependency relation from i to j would not create an illegal dependency, a probability model is then consulted to determined whether that relation is possible at all and how probable it is. A probability model can be represented as a big table. The dimensions of the table are all the properties of the existing partial parse and the proposed extension that are deemed relevant for this task. This is the history-based approach [Black, E., et al. 1992. Towards history-based grammars: Using richer models for probabilistic parsing. In Proceedings of the DARPA Speech and Natural Language Workshop]. Possible relevant properties are the token identity of the child and the head, the PoS of the child and the head and some of their neighboring tokens, the role of the proposed relation, the number and/or roles of any children that the child or the head already have, the distance (in tokens) from the child to the head, the occurrence of certain PoS between the two and so on. See [Collins, 1999; Charniak, 2000; Eisner, 2000]. The value of a table cell is the probability that the given relation occurs in the context described by the relevant properties. Typically, these values are estimated from a treebank. Often, there are too many relevant properties and too little corpus data to adequately estimate the probability for all combinations (this is the so-called data sparsity problem). Therefore in such instances some kind of smoothing of probabilities has to be applied. See also the above references for possible smoothing methods.

Considering the method of the present invention in more detail, a tokenized and part-of-speech tagged sentence is initially input into a parser that operates according to the first aspect of the invention. Starting with the first token, the parsing method calculates a partial parse of the sentence by assigning a role and a head to this token. The probability of this partial parse is also calculated. This process of determining a potential partial parse and its associated probability is repeated for all possible heads and roles of the first token.

The probability of each potential partial parse is conveniently derived from a tree bank as described above.

The parsing process stores the A most likely parses relating to the first token. Parameter A can be set to any desired value that meets the constraints (e.g. run time, memory) of a system thereby allowing the method to be scalable.

The parsing method then moves onto the next token in the input.

At any subsequent step of the parsing process (i.e. from tokens 2 to n) the parser uses the partial parses derived in the previous step as its starting point. Starting from each of these partial parses in turn the parser calculates all possible extensions to the partial parse along with the probability associated with the extended partial parse. Once again the A most likely extended partial parses are stored.

As the parsing for each token i is completed the parser will preferably delete the partial parses derived in relation to token i−1 in order to reduce the memory requirements of the system. The A most likely partial parses derived for token i then become the starting positions when considering the extension of the dependency relation for token i+1.

The list of A most likely partial or complete parses of the input sentence is an example of a data structure which is referred to herein as a “beam”. In keeping with the “beam” structure terminology the parameter A is used interchangeably below with the term “BEAM_SIZE”.

The freely scalable parameter A/BEAM_SIZE directly influences the runtime and space requirements of a system incorporating the parsing method of the present invention. Varying this parameter allows a continuum from full determinism (BEAM_SIZE=1, runtime O(n²)) to deriving all possible parses (BEAM_SIZE=n²+R, where R is the maximum number of possible dependency labels [roles] for any token). The parameter can be set according to the time, space and accuracy constraints of the application.

It can be shown that the time needed to derive parses according to the present invention is O(n²×BEAM_SIZE×log₂(BEAM_SIZE)×R), with n the number of tokens in the sentence and R the maximum number of possible dependency labels (roles) for any token. The memory space needed to derive these parses is O(n×BEAM_SIZE).

Conveniently the method of the present invention will also include the step of checking that a possible partial parse does not result in a dependency cycle.

The parsing method will also check for each possible role whether that role is possible for that relation as described above.

Preferably the information relating to the A most likely parses derived in relation to each token comprises the probability of the partial parse, the role of each token and the position of each token's head. Conveniently, this information may be contained within two arrays of size n plus a probability value.

It is noted that the method of the present invention may derive both non-projective and projective dependency structures. Depending on the application of the method (and possibly the language which is being parsed) the method may include additional steps such that only projective parses are calculated. In such instances the information that is stored for each of the A partial parses between processing steps includes the probability of the partial parse, the role of the token, the position of the token's head and additionally the distance to a token's leftmost left child. This means that for a parsing method in accordance with the present invention that is restricted to projective dependency structures only, the derived partial parses have to be represented by at least three arrays of size n.

Conveniently, the accuracy associated with the present invention may be improved by using the concept of so-called left and right STOP children (as described in Collins, 1999; Eisner, 2000; and also Eugene Charniak, “A Maximum-Entropy-Inspired Parser”, In: Proceedings of NAACL'00, p. 132-139) in order to capture the probability of how likely a token is to have no more children to that side.

In a second aspect of the present invention there is provided a data processing program for execution in a data processing system comprising software code portions for performing a method according to the first aspect of the invention when said program is run on said computer.

In a third aspect of the present invention there is provided a computer program product stored on a computer usable medium, comprising computer readable program means for causing a computer to perform a method according to the first aspect of the invention when said program is run on said computer.

The above-described operating program to implement the above-described method may be provided on a data carrier such as a disk, CD- or DVD-ROM, programmed memory such as read-only memory (Firmware), or on a data carrier such as optical or electrical signal carrier. For many applications the above-described methods will be implemented on a DSP (Digital Signal Processor), ASIC (Application Specific Integrated Circuit) or FPGA (Field Programmable Gate Array). Thus code (and data) to implement embodiments of the invention may comprise conventional program code, or microcode or, for example, code for setting up or controlling an ASIC or FPGA. Similarly the code may comprise code for a hardware description language such as Verilog (Trade Mark) or VHDL (Very high speed integrated circuit Hardware Description Language). As the skilled person will appreciate such code and/or data may be distributed between a plurality of coupled components in communication with one another.

The present invention will now be described with reference to the following non-limiting preferred embodiments in which:

### BRIEF DESCRIPTION OF THE DRAWINGS

FIGS. 1a and 1b, as hereinbefore discussed, show the phrase structure and dependency structure approaches to represent syntax

FIG. 2 shows dependency trees illustrating how different parser techniques arrive at the same complete parse through different partial parses

FIG. 3 is a flow chart depicting an aspect of the present invention

FIG. 4 is a representation of a partial parse of a sentence

FIG. 5 shows a dependency tree of a projective parser

FIG. 6 shows a dependency tree illustrating dependency relations that result in cycles

FIGS. 7 and 8 show a sentence parsed in accordance with an aspect of the present invention (Note: the parsing of the full sentence is split over the two Figures)

FIG. 9 shows the effect of the BEAM_SIZE parameter (parameter A) on accuracy and runtime

FIG. 10 shows the effect of sentence length (number of tokens) on accuracy and runtime

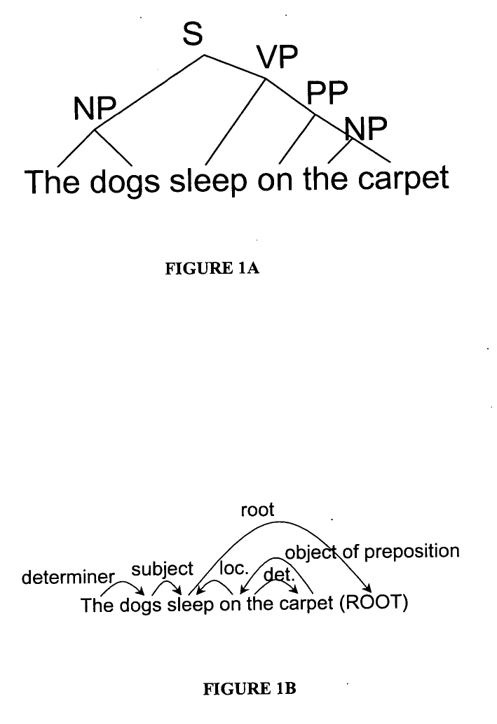

### DETAILED DESCRIPTION OF THE PREFERRED EMBODIMENTS

As discussed above the parsing method of the present invention determines the heads and grammatical roles of tokens strictly from left to right, i.e. in the first step, it determines which role the first token takes and which other token is the first token's head, in the second step it determines the same for the second token, and so on until the last token.

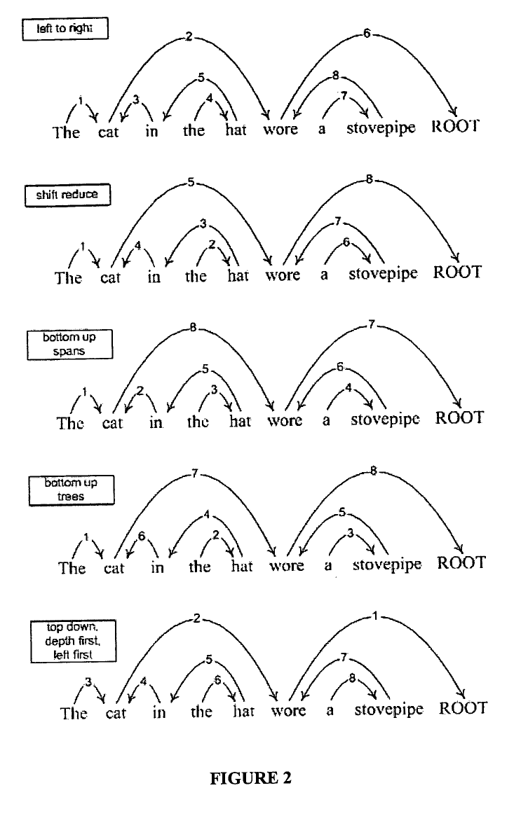

Prior art parsing methods use various other orders in which to determine heads and roles of the tokens. This is illustrated in FIG. 2 for the example sentence “The cat in the hat wore a stovepipe (ROOT)”.

In FIG. 2 the numbers on the arrows between the words indicates the different orders in which the dependencies are inserted into the full parse. The parsing order of the present invention is shown at the top of the Figure and is labelled “left to right”. Four prior art parsing methods are also depicted and it can be seen that the parsing order is different in each case. The “shift reduce” order is used by e.g. Nivre and Scholz, 2004.

The “bottom up spans” order is used by e.g. Eisner, 2000. The “bottom up trees” order is used by e.g. Collins, 1999.

It is noted that, in addition to the different parsing orders, most prior art (except Tapanainen and Järvinen, 1997) is restricted to deriving projective dependency structures only. The parsing method of the present invention is capable of deriving both non-projective and projective structures.

As described above, the parsing method of the present invention uses an instance of a data structure referred to herein as a “beam”. The “beam” structure is the list of A most likely partial or complete parses of the input sentence that is derived at each token and the “BEAM_SIZE” is the size of the list, i.e. the number of parses (≡the parameter A) retained in a memory storage during the parsing process. Since the parsing process of the present invention uses the partial parses derived in relation to the previous token the method actually uses two instances of a “beam” data structure. For any token i the list of A partial parses derived for the (previous) token i−1 can be thought of as the “old_beam” and the list under construction for token i itself can be termed the “new_beam”.

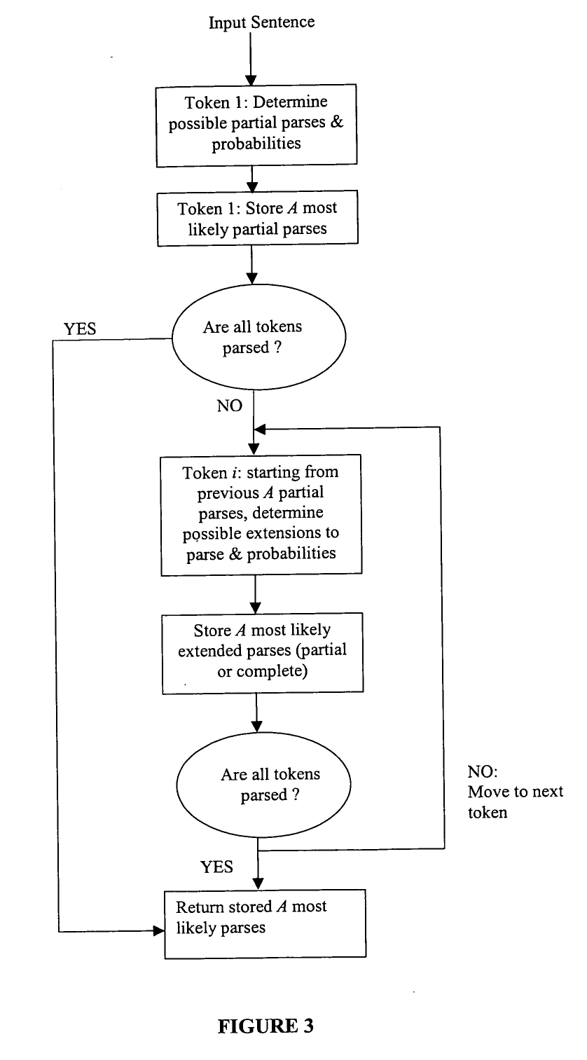

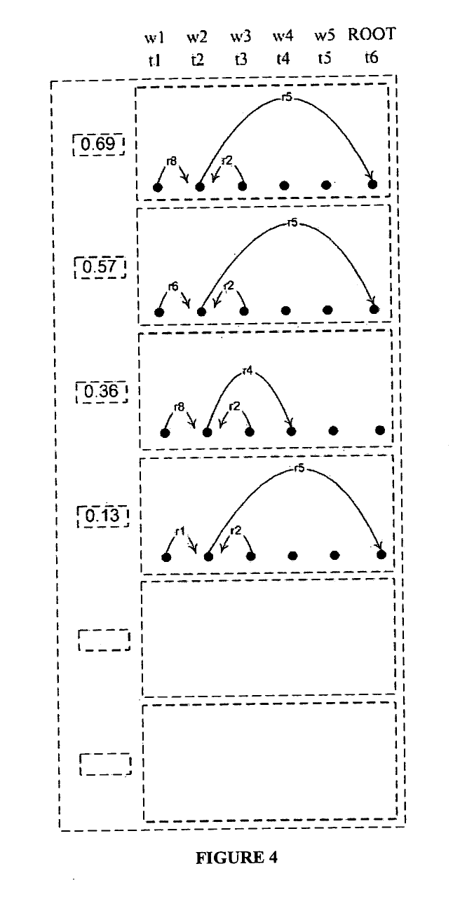

An overview of the parsing method is depicted in the flow chart of FIG. 3. FIG. 4 also depicts a representation of an example beam.

Turning to FIG. 3, an overview of the basic algorithm is shown. In the Figure a language sentence/utterance comprising n tokens is input into the parsing process. Starting at the first token the process determines possible partial parses and their associated probabilities. A beam structure of size A (BEAM_SIZE) is then constructed.

If the input comprises a single token only then the parsing process will be complete and the parser will return the A most likely parses.

Assuming that the input comprises more than one token, the process then moves onto the second token and taking each of the A partial parses from step i=1 in turn all possible next extensions of the partial parse are calculated and the associated probabilities computed. A further list of the A most probably partial parses is thus created (i.e. a new list-new_beam).

The process then checks to see if all n tokens have been parsed. If yes, the parsing process ends. If no, then the process repeats until all tokens have been parsed.

In more general terms the process can be described as follows: At the beginning of step i of the parser (1≦i≦n), one beam (old_beam) contains partial parses of the input sentence in which all tokens t<i have been assigned a role and a head (if i=1, old_beam contains only the empty parse). For each partial parse in old_beam in turn, starting at the most probable one, the parser then computes all possible next extensions of that parse by one dependency relation, i.e. by assigning a role and a head to token i. It computes these extensions by checking for each token i≠j whether a dependency relation from i to j would not create a cycle, and if not, by checking for each possible role whether that role is possible for that relation.

For each possible extended parse, the parser computes the extended parse's probability by multiplying the probability of the original partial parse, p(b), with the probability of the extension [dependency from token i to token j with role r] given the original partial parse, p(r(i,j)|b). It then tries to insert the extended parse at the appropriate place into the other beam (new_beam). If the probability of the extended parse is lower than that of the lowest element of new_beam, the extended parse is not inserted into new_beam.

Otherwise, it is inserted. If new_beam was already full before the insertion, the insertion causes the lowest element of new_beam to be “pushed out at the end”. That element will therefore not be considered in any further parsing step.

Computing and inserting new extensions of the partial parses in old_beam for step i ends if either all elements of old_beam have been extended or an element in old_beam is reached whose probability is already lower than the lowest element of new_beam (As adding extensions can only lower, never increase probability, any extension to this or lower elements would never make it into new_beam).

At the end of step i, the old and the new beam are normally swapped, i.e. the new_beam of step i becomes the old_beam of step i+1, while the old_beam of step i is emptied and becomes the new_beam of step i+1. If, however, at the end of step i new_beam is empty, this means that token i could not be attached in any partial parse. This can be due to an incorrect PoS tag for token i, or for its head. Token i is then just left unattached, the beams are not swapped and the parser continues with step i+1.

At the end of step n, after a possible swap, old_beam contains the up to BEAM_SIZE complete parses for the input sentence, ordered by probability.

Pseudo-code encompassing the above description of the basic process is detailed in the Pseudo-code section below.

FIG. 4 depicts an example of a beam structure. In this example a sentence “w1 w2 w3 w4 w5” is in the process of being parsed. There are six tokens: t1 corresponding to w1, t2 (w2), t3 (w3), t4 (w4), t5 (w5) and t6 which corresponds to the ROOT.

It can be seen that the first three tokens have been processed. The BEAM_SIZE is six in this example. In other words the parser running the parsing method has capacity to store the six most likely partial parses at any one time. In this case, however, there are only four partial parses in the beam.

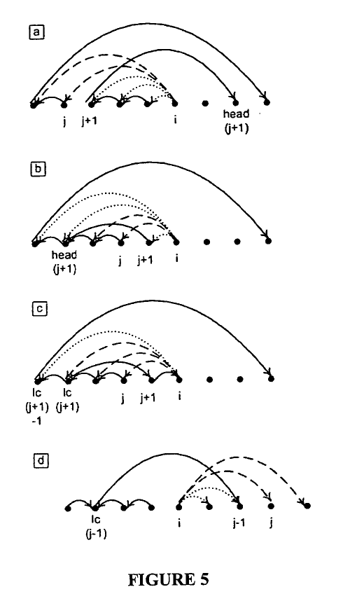

The basic algorithm just described might produce non-projective dependency structures, i.e. structures in which two dependency relations cross. To get only projective dependency structures, additional restrictions need to be considered when extending a partial parse. These are illustrated in FIG. 5 in which lc=leftmost left child, existing dependencies are depicted by the solid lines, allowable dependencies are depicted by the dotted lines and crossing dependencies are depicted by the dashed lines. [Pseudo-code encompassing an algorithm restricted to projective structures only is detailed in the Pseudo-code section below]

It is noted that no conditions have to be checked if the proposed relation goes only to an immediate neighbour of the current token (i.e. from i to i−1 or i+1), as such a short dependency cannot cross any other.

In general, more conditions have to be checked for potential extensions to the left than for those to the right because there is more potentially conflicting structure present to the left of the current token. The parser checks shorter potential extensions before longer extensions. This means that while checking further and further to the left, it can stop searching into that direction if it reaches a token j whose immediate right neighbour's relation spans over i (see FIG. 5a).

If the parser reaches a token j whose immediate right neighbour's relation goes to the left, it can jump over some tokens and continue the checking at that right neighbour's head (see FIG. 5b). Likewise, if it reaches a token j whose immediate right neighbour has a leftmost left child, it can jump over some tokens and continue the checking at the token to the left of that right neighbour's leftmost left child (see FIG. 5c). Note that that right neighbour's leftmost left child itself is also jumped, as a relation to it would result in a cycle. While checking further and further to the right, the parser can stop searching into that direction if it reaches a token j whose immediate left neighbour has a leftmost left child that spans over i (see FIG. 5d).

To implement these checks efficiently, the parser keeps track of each token's leftmost left child in each partial parse. This means that for the parser restricted to projective dependency structures, a partial parse has to be represented by at least three arrays of size n. The first array stores each token's role. The second array stores each token's head. This can be done by storing the relative distance, counted in tokens, from the token to its head (or by storing the head's absolute index). A negative distance means the head is to the left of the token while a positive distance means the head is to the right of the token. The third array stores the distance to a token's leftmost left child (if any). The third array need not store anything for the first token in the sentence, as that token cannot have a left child, but instead must store the distance to the leftmost left child for the special ROOT token. The non-projective variant of the parser does not need the information about the leftmost left child and therefore needs only two arrays of size n to store a partial parse.

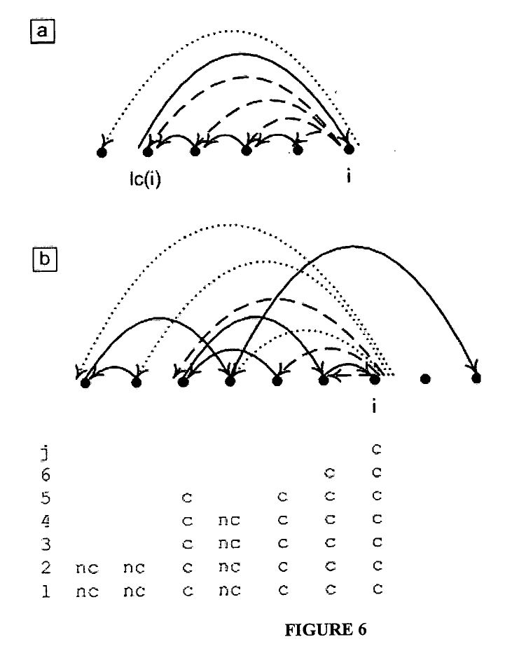

FIGS. 6a and 6b illustrate how the number of potential dependency relations is limited by the need to prevent cycles in parses (a cycle being a loop of dependency relations that returns to any given token i).

FIG. 6a depicts a parser which is restricted to projective parsers only (i.e. crossing dependencies are not allowed). In the Figure existing parses are shown by the solid lines. Potential parses are shown by either dotted or dashed lines. A dashed dependency from token i would create a cycle with some or all of the existing dependencies (solid lines) and is therefore not allowable. Dotted dependencies from token i are allowable.

In this case (projective only), the parser only needs to check whether the current token i has a leftmost left child lc(i) which is to the left of the proposed head j. If that is the case, the proposed dependency would introduce a cycle, either directly, if j is i's leftmost left child, or indirectly, if j is spanned by the relation to i's child as there is no way one can follow the head path (i.e. go from j to heads(j) to head(head(j)) etc.) without eventually ending up at either lc(i) or i (or crossing the spanning relation, which we excluded).

FIG. 6b depicts a parser in which both projective and non-projective structures are allowed. In this instance the check for cycles is more complicated

The idea is that while the parser checks the tokens j=i−1 down to 1 for possible extensions, it also keeps track of where each token's head path leads. The head path can lead to a token to the right of i, which is fine: as those tokens have not been assigned a head yet, they cannot lead back to i. So the parser follows the same head path again and marks each token on the path as “not leading to a cycle”. If, on the other hand, the head path leads back to i, the parser marks all tokens on the path as “leading to a cycle”. In future cycle checks for other j for the same i, whenever the parser encounters an already marked token, it can stop following the head path as it already knows where it will lead (it still marks all yet unmarked tokens on the path). This procedure means that each token from the first one up to i will be traversed only twice: for following the path to discover its end and for marking the tokens). So the total time for the cycle checks for token i is bound by O(2×i).

The table at the bottom of FIG. 6b shows how more and more tokens are marked as j decreases. “c” denotes cycle and “nc”=no cycle.

Pseudo-code encompassing algorithms that check for cycles is detailed in the Pseudo-code section below for both the projective and non-projective cases.

The time needed for inserting a new element at the correct position of new_beam is at most O(log₂ BEAM_SIZE). This means that the total runtime of the parser is O(n×BEAM_SIZE×(n×log₂ BEAM_SIZE+2×n)) for the unrestricted, non-projective case, and O(n×BEAM_SIZE×n×log₂ BEAM_SIZE)=O(n²×BEAM_SIZE×log₂ BEAM_SIZE) for the restricted, projective case.

Collins, 1999, Eisner, 2000, and also Eugene Charniak, “A Maximum-Entropy-Inspired Parser”, In: Proceedings of NAACL '00, p. 132-139, both use so-called left and right STOP children, or termination symbols, in their probabilistic parsers to capture the probability of how likely a token is to have no more children to that side. The same concept can also be applied to the parsing method of the present invention.

Implicit STOP children occur whenever a newly introduced dependency “closes off” some tokens, i.e. places them in a configuration in which they cannot act as head to further tokens without causing dependencies to cross. The left STOP child implicitly occurs for token i+1 after the current token i has received its head, as at that stage all tokens to the left of token i+1 have received their head, so token i+1 cannot receive any more left children. The right STOP child of a token k implicitly occurs in one of two configurations. Either k<i, the current token i has a dependency which spans over k (i.e. head(i)<k) and no other dependency already spans k. Or k<i+1, i has received its head and i+1 has a leftmost left child whose dependency spans over or originates at k (i.e. lc(i+1)≦k) and no other dependency already spans k, as no token to the right of i+1 can then become a child of k without crossing with the dependency between i+1 and its leftmost left child and i+1 itself cannot become a child of k without creating either a cycle or a crossing. It would therefore be possible to say that the probability of an extended parse is
the probability of the original partial parse
times the probability of the newly added dependency given the original parse
times the probability of the next token receiving its left STOP child, given the extended parse
times the probability of all tokens k, spanned according to the conditions detailed above, receiving their right STOP children, given the extended parse
   i.e.
   p(b)×p(r(i,j)|b)×p(leftSTOP(i+1)|b, r(i,j))×II_{((k<i and head(i)<k) or (k<i+1 and lc(i+1)≦k)) and there is no with 1<k<head(1) or head(1)<k<1}p(rightSTOP(k)|b, r(i,j)).

If this were to be implemented directly as just described, it would introduce another loop (over all spanned ks) inside the innermost loops (over r) of the parser algorithm, thereby increasing the theoretical runtime. However, it is noted that such an approach would unnecessarily duplicate many computation steps. Therefore computations which do not depend on j or r can be moved out of the loops. The resulting pseudo-code is shown in the Pseudo-code section below. The simplification is based on the (linguistically plausible) assumption that the left and right STOP probabilities of j only depend on j's children so far and on direct properties of j (e.g. its PoS, role). In particular, the STOP probabilities of j must not depend on the presence or absence of children of other tokens.

If probabilities of a dependency p(r(i,j)|b) or of a STOP child p(leftSTOP(k)|b, r(i,j)) or p(rightSTOP(k)|b, r(i,j)) can be zero in the given probability model (e.g. because no general smoothing of estimated probabilities occurred), it is possible to further reduce computational load by avoiding steps that are bound to result in an extended parse with a probability of zero. The shortcuts that this introduces to the parsing method are detailed in the pseudo-code section below. In addition, if it is known that dependencies into a certain direction are not possible for certain words or PoS tags, it is possible to avoid one of the two loops over j in these cases.

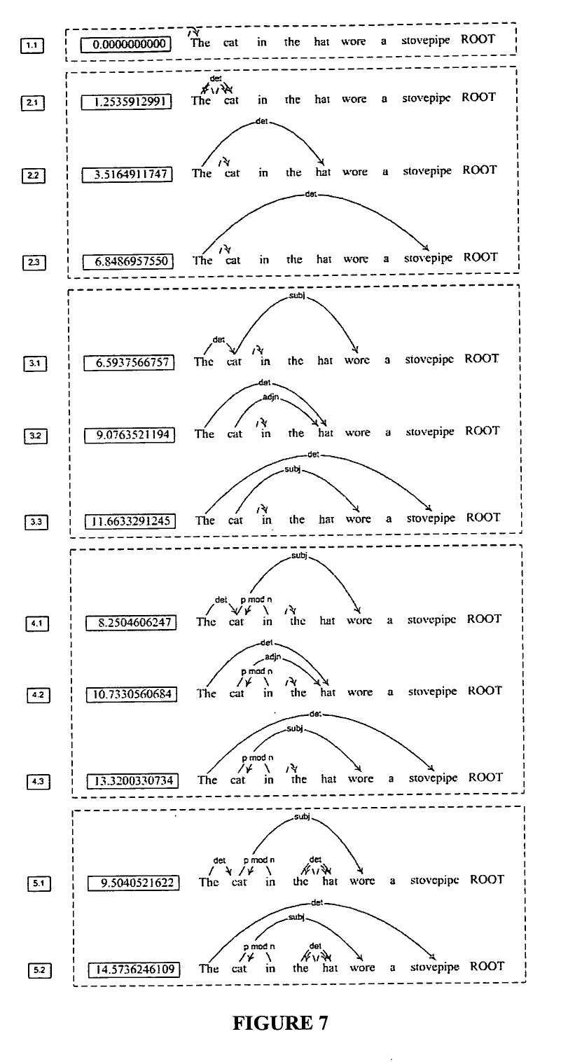

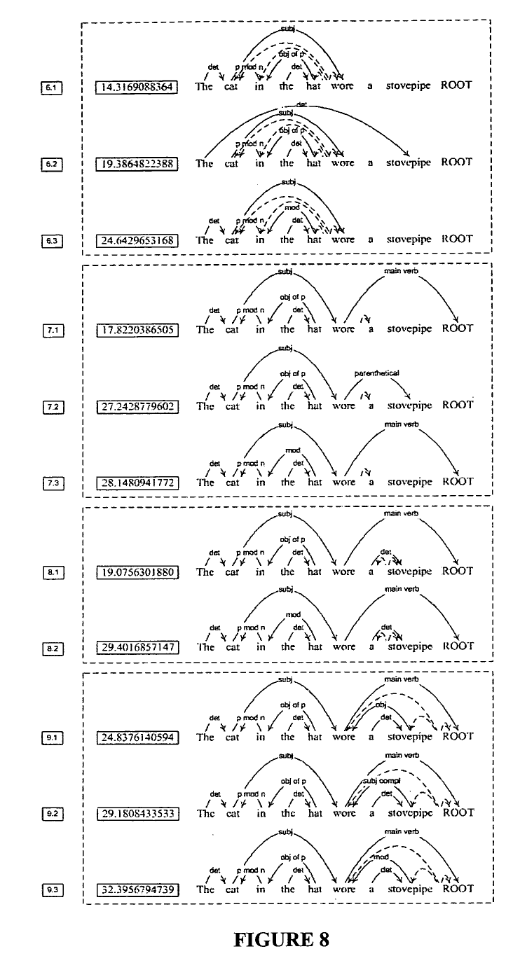

FIGS. 7 and 8 show how the proposed parser parses an example sentence. FIG. 7 relates to the parsing of the first four tokens of the sentence and FIG. 8 shows the remaining tokens of the sentence.

Each box in FIGS. 7 and 8 shows the result of one parsing step (i.e. the result of extending the parses). The BEAM_SIZE in this case is three and the values shown on the left of each box are −log₂(p(partial parse)) to prevent underflow (so lower numbers equate to higher probabilities). Dashed arrows indicate STOP children/probabilities taken into account in each step.

The logarithmic probabilities are those actually computed by the parser for this sentence. The parser was trained on, i.e. the probability model was estimated from, 80% of the written part of the International Corpus of English—Great Britain (ICE-GB), which amounts to 19,143 sentences, containing 381,415 words. The phrase structure annotations of ICE-GB were converted into dependency structures using an approach similar to that described in Collins, 1999. The dependency roles were based on a mapping from a combination of the functional and categorical annotations in ICE-GB to a set of 41 roles.

The probability model uses the approach of conditional history-based models (see Collins, 1999, p. 58, 126 ff. for an overview) to approximate the probability p(r(i,j)|b), which is impossible to estimate directly due to sparse data, by a simpler formula in which conditioning takes place not on the whole history but only on those parts of it deemed relevant. Which parts these are exactly does not in any way influence the way in which the parser proceeds and the details will therefore not be disclosed here. However, it is mentioned that the results reported below do not include bilexical probabilities (e.g. relating a word and its head word) in the probability model.

With respect to FIGS. 7 and 8 the following points are noted:
i) Parse 3.1 shows an extension of the parse 2.1. It is noted that other extensions of the same original parse are too unlikely and have been pushed out of the beam by the partial parses 3.2 and 3.3.
ii) Parse 4.2 will be discontinued in the next step because a potential det relation of the second “the” will have nowhere to link to (it is noted that it is not possible for det to link to something already having an adjn child).
iii) The parse extension at token 5 resulted in only two beam elements.
iv) Parse 6.2 will be discontinued in the next because the verb will have nowhere to link to.
v) Parse 7.2 will be discontinued in the next step because a potential det relation of the second “the” will have nowhere to link to (it is noted that it is not possible for det to link to something already having a parenthetical child).
vi) The parse extension at token 8 resulted in only two beam elements. Further, the parse extension at 8.2 will be discontinued in the next step as all potential extensions will be too unlikely.

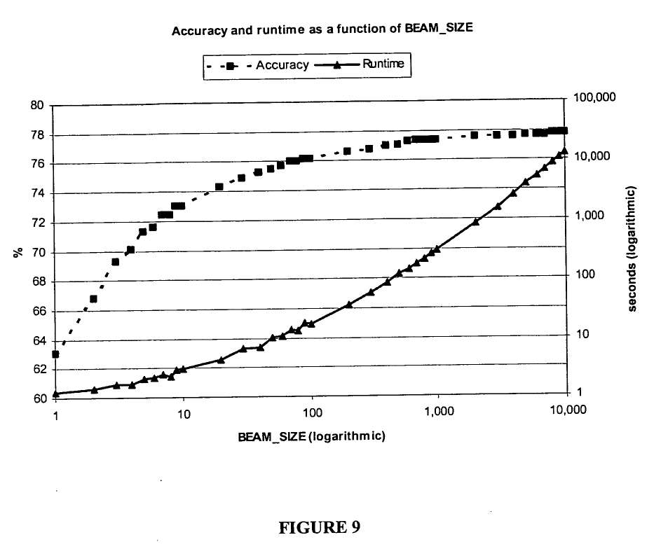

FIG. 9 shows accuracy and runtime as a function of the value of BEAM_SIZE when tested on 10% of the written part of ICE-GB (disjoint from the 80% used for training and the 10% used for developing the probability model) using the gold standard PoS tags, i.e. the original ICE-GB tags mapped to a set of 46 PoS tags. That test set contained 2392 sentences.

Accuracy (shown on the left hand y axis in FIG. 9) was measured as the percentage of non-punctuation tokens for which both the role and the distance were predicted correctly. Runtime (shown on the right hand y axis) was measured in seconds for the whole test set on a 1 GB RAM, Dual 2.8 GHz Intel® Xeon® machine.

BEAM_SIZE was increased in steps of 1 up to a size of 10, then in steps of 10 up to 100, steps of 100 up to 1,000 and steps of 1,000 up to 10,000. While the first two steps yield an absolute increase in accuracy of 3.7% and 2.5% respectively, the last two steps do not yield any noticeable improvement at all.

The upper bound on accuracy given the current (limited) probability model seems to be around 77.8%. Given that an accuracy of 76.8% can be reached with a BEAM_SIZE of 300 in only 1/150 the time needed to reach 77.8%, increasing the BEAM_SIZE beyond that point does not make much sense in a practical application.

These figures show that at practical speeds (e.g. 59 seconds for 2392 sentences=0.025 sec/sentence) not much performance is lost to search error, i.e. parses that do not get pursued because they “fall outside the beam” at some point would rarely make it to the top anyway. This is a relevant finding because alternative chart-based methods do not have any search error, i.e. they always find the most likely parse according to the probability model.

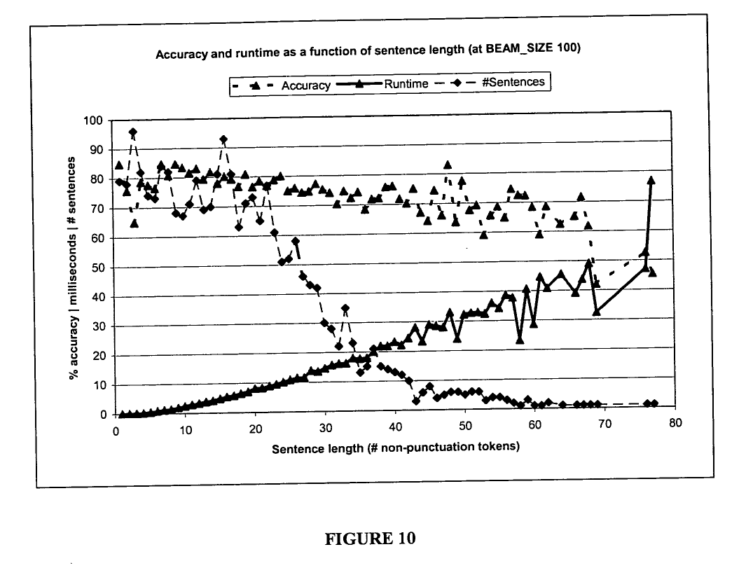

FIG. 10 shows a breakdown of runtime and accuracy by sentence length (excluding punctuation tokens) for a BEAM_SIZE of 100, and also how often sentences of each length occurred in the test material (and therefore how reliable individual accuracy figures for these lengths are).

The test material used in FIG. 10 was the same ICE-GB test set of 2392 sentences using gold standard PoS tags. Accuracy again was measured as the percentage of non-punctuation tokens for which both the role and the distance were predicted correctly. Runtime was measured in milliseconds per sentence on a 1 GB RAM, Dual 2.8 GHz Intel® Xeon® machine, averaged over all sentences of a certain length in the test set. The dashed line with diamond shaped data points shows how many sentences of each length there are in the test set and thereby how reliable measurements for each data point are.

Although measurements for longer sentences are a bit erratic due to the small number of sentences averaged over, the overall trend is still promising. Unsurprisingly, accuracy drops with increased sentence length, but it is still almost always over 60% up to a sentence length of 68 non-punctuation tokens (in this case: 82 tokens overall). Runtime shows the expected polynomial increase but the slope is typically not very steep. Even the longest sentence (at 77 tokens), which seems to be an outlier, is 11 times longer than a 7-token sentence but takes only 64 times as long to parse (76.76 versus 1.19), instead of 121 times as the theoretical quadratic runtime order would suggest. The 76-token sentence takes only 39 times as long as the 7-token sentence.

Examples of Pseudo-code in Accordance with the Present Invention

1) Basic Algorithm for Performing the Method of the Present Invention

clean/initialize old_beam
insert empty dependency structure with probability 1.0 into first
old_beam element
for token i=1 to n

clean/initialize new_beam
for old_beam element b=1 to last element for which p(b) > p
(last element of new_beam) // max. BEAM_SIZE

for token j=i−1 down to 1

if dependency from i to j would not lead to cycle

for all possible roles r of token i

compute p(r(i,j) | b) of dependency r
between tokens i and j given b
if p(b) * p(r(i,j) | b) > p(last element
of new_beam)

insert b with r(i,j) into new_beam
according to p(b) * p(r(i,j) | b)

for token j=i+1 to n+1

for all possible roles r of token i

compute p(r(i,j) | b) of dependency r
between tokens i and j given b
if p(b) * p(r(i,j) | b) > p(last element of
new_beam)

insert b with r(i,j) into new_beam
according to p(b) * p(r(i,j) | b)

if new_beam not empty

swap new_beam and old_beam

return old_beam

2) Parsing Algorithm Restricted to Projective Dependencies Only (Changes from the Basic Algorithm are Shown in Bold).

clean/initialize old_beam
insert empty dependency structure with probability 1.0 into
first old_beam element
for token i=1 to n

clean/initialize new_beam
for old_beam element b=1 to last element for which
p(b) > p(last element of new_beam) // max. BEAM_SIZE

for token j=i−1 down to 1

if j<i−1

if head(j+1)>i: stop for-loop
if head(j+1)<j: continue for-loop at
j=head(j+1)
if exists(lc(j+1)) and lc(j+1)<j: continue
for-loop at j=lc(j+1)−1

if dependency from i to j would not lead to cycle

for all possible roles r of token i

compute p(r(i,j) | b) of dependency r
between tokens i and j given b
if p(b) * p(r(i,j) | b) > p( last
element of new_beam )

insert b with r(i,j) into new_beam
according to p(b) * p(r(i,j) | b)

for token j=i+1 to n+1

if j>i+1

if exists(lc(j−1)) and lc(j−1)<i: stop for-loop

for all possible roles r of token i

compute p(r(i,j) | b) of dependency r
between tokens i and j given b
if p(b) * p(r(i,j) | b) > p( last element of
new_beam )

insert b with r(i,j) into new_beam
according to p(b) * p(r(i,j) | b)

if new_beam not empty

swap new_beam and old_beam

return old_beam

3) Additional Pseudo Code for Checking Whether a Dependency Results in a Cycle

Changes from the algorithms at (1) and (2) above are shown in bold.

| If crossing dependencies are not allowed: | | Code for insertion into the |
|---|---|---|
| | for token j=i−1 down to 1 | basic algorithm in (1) above |

[ if dependency from i to j would not lead to cycle ]
if not (exists lc(i) and j>=lc(i))

for all possible roles r of token i

...

If crossing dependencies are allowed:

make empty array ar with i elements
set a[i] to “cycle”
for token j=i−1 down to 1

| [ if dependency from i to j would not lead to cycle ] | |
|---|---|
| k=j | |
| while k<i and ar[k] is empty | Code for insertion into the |

| | |
|---|---|
| k=head(k) | algorithm in (2) above |

if k>i

result=”no cycle”

else

result=ar[k]

k=j
while k<i and ar[k] is empty

ar[k]=result
k=head(k)

if result is “no cycle”

for all possible roles r of token i

...

4) Parsing Algorithm that Computes Left/Right STOP Probabilities (Probability that a Token Does not Take any More Left/Right Children).

Changes from the code in section (2) shown in bold.

...

| | |
|---|---|
| for old_beam element b=1 to last element for which p(b) > p(last element of new_beam ) | // maximally BEAM_SIZE |

| | |
|---|---|
| set spannedByNext = spannedByCurr = 1.0 | // right STOP probabilities |
| if exists(lc(i+1)) | |

for j=i down to lc(i+1)

if j<i

if head(j+1)<j: continue for-loop at j=head(j+1)
if exists(lc(j+1)) && lc(j+1)<j: continue for-loop at j=lc(j+l)−l

| | |
|---|---|
| spannedByNext *= p(rightSTOP(j) \| b) | // right stop probabilities of tokens spanned by i+1 |

for token j=i−1 down to 1

if j<i−1

if head(j+1)>i: stop for-loop
if head(j+1)<j: continue for-loop at j=head(j+1)
if exists(lc(j+1)) and lc(j+1)<j: continue for-loop at j=lc(j+l)-l

if dependency from i to j would not lead to cycle

for all possible roles r of token i

| compute p(r(i,j) \| b) of dependency r between tokens i and j given b | |
|---|---|
| p(r(i,j) \| b) *= p(leftSTOP(i+1) \| b, r(i,j)) | // p(leftSTOP(i+1) \| b, r(i,j))=p(leftSTOP(i+l) \| b) |
| if exists(lc(i+1)) | |

| | |
|---|---|
| p(r(i,j) \| b) *= p(rightSTOP(j) \| b, r(i,j)) * spannedByNext | // adapting right STOP probabilities |
| p(r(i,j) \| b) /= p(rightSTOP(j) \| b) | // of tokens spanned by i+1 |

else

| | |
|---|---|
| p(r(i,j) \| b) *= spannedByCurr | // right STOP probabilities of tokens spanned by i |

if p(b) * p(r(i,j) | b) > p( last element of new_beam )

insert b with r(i,j) into new_beam according to p(b) * p(r(i,j) | b)

| | |
|---|---|
| spannedByCurr *= p(rightSTOP(j) \| b) | // right STOP probabilities of tokens spanned by i |

for token j=i+1 to n+1

if j>i+1

if exists(lc(j−1)) and lc(j−1)<i: stop for-loop

| | |
|---|---|
| if j=i+1 | // i is lc(i+1) |

if not exists(1c(i+1))

spannedByNext = p(rightSTOP(i) | b)

for all possible roles r of token i

compute p(r(i,j) | b) of dependency r between tokens i and j given b
p(r(i,j) | b) *= spannedByNext * p(leftSTOP(i+1) | b, r(i,j))
if p(b) * p(r(i,j) | b) > p( last element of new_beam )

insert b with r(i,j) into new_beam according to p(b) * p(r(i,j) | b)

...

In the above pseudo-code, first, if token i+1 has a leftmost left child, we compute the right STOP probabilities of all tokens spanned by that dependency (including the STOP probability of the leftmost left child itself) and not spanned by another dependency. The resulting probability spannedByNext, enters directly into the probability of an extended parse if the extension goes to the right (as a dependency of i going to the right can only result in a new left child to some token 1>i and therefore cannot influence the right STOP probabilities of any token k≦i, see the above assumption). For extension going to the left, spannedByNext has to be adapted to account for the fact that the right STOP probability of j has probably changed due to the addition of an extra right child. This adaptation is carried out in the inner loop (over roles) by dividing through the right STOP probability for j based on the original partial parse and multiplying by the new right STOP probability for j based on the extended parse. The right STOP probabilities of tokens spanned by a dependency from i to a left head j can be computed in the same loop that checks potential heads j in the first place. The resulting probability spannedByCurr, is only used in the probability computation of the extended parse if a leftmost left child of i+1 does not exist (as otherwise the right STOP probabilities for the spanned tokens are already included in spannedByNext).

5) Pseudo-code with Shortcuts that can be taken if Probabilities can be Zero

The shortcuts avoid computation steps that are bound to result in zero probability parses, i.e. in partial parses that cannot be part of the highest ranking complete parse.

| | |
|---|---|
| ... | |
| for old_beam element b=1 to last element for which p(b) > p(last element of new_beam ) | // maximally BEAM_SIZE |
| set spannedByNext = spannedByCurr = 1.0 | // right STOP probabilities |
| incompleteToken = −1 | |
| if exists(lc(i+1)) | |
| for j=i down to 1c(i+1) | |
| ifj<i | |

```
            if head(j+1)<j: continue for-loop at j=head(j+1)
            if exists(lc(j+1)) && lc(j+1)<j: continue for-loop at j=lc(j+1)−1
```

| | |
|---|---|
| if p(rightSTOP(j) \| b) > 0 | |
| spannedByNext *= p(rightSTOP(j) \| b) | // right STOP probabilities of tokens spanned by i+1 |
| else | |
| if incompleteToken != −1 | // found second incomplete token |
| continue outer for-loop at next b | |
| incompleteToken = j | |
| if p(leftSTOP(i+1) \| b) > 0 | // p(leftSTOPfi+1) \| b)=p(leftSTOP(i+1) \| b, r(i,j)) |
| for token j=i−1 down to I | |
| if j<i−1 | |
| if head(j+1)>i: stop for-loop | |

```
          if head(j+1)<j: continue for-loop at j=head(j+1)
          if exists(lc(j+1)) and lc(j+1)<j: continue for-loop at j=lc(j+l)-l
        if j < incompleteToken: stop for-loop
        if dependency from i to j would not lead to cycle
```

for all possible roles r of token i

```
            compute p(r(i,j) | b) of dependency r between tokens i and j given b
            if p(r(i,j) | b) == 0: continue for-loop at next r
```

| | |
|---|---|
| p(r(i,j) \| b) *=p(leftSTOP(i+1) \| b, r(i,j)) | //p(leftSTOP(i+1) \| b, r(ij))=p(leftSTOP(i+1) \| b) |
| if exists(lc(i+1)) | |

if p(rightSTOP(j) | b, r(i,j)) == 0: continue for-loop at next r

| | |
|---|---|
| p(r(i,j) \| b) *= p(rightSTOP(j) \| b, r(i,j)) * spannedByNext | // adapting right STOP probabilities |
| if p(rightSTOP(j) \| b) > 0 | // of tokens spanned by i+1 |
| p(r(i,j) \| b) /= p(rightSTOP(j) \| b) | |
| else | |
| p(r(i,j) \| b) *= spannedByCurr | // right STOP probabilities of tokens spanned by i |

```
            if p(b) * p(r(i,j) | b) > p( last element of new_beam )
                insert b with r(i,j) into new_beam according to p(b) * p(r(i,j) | b)
        if p(rightSTOP(j) | b) == 0: stop for-loop
```

| | |
|---|---|
| spannedByCurr *= p(rightSTOP(j) \| b) | // right STOP probabilities of tokens spanned by i |
| if incompleteToken == −1 | |
| for token j=i+1 to n+1 | |
| if j>i+1 | |

if exists(lc(j−1)) and lc(j−1)<i: stop for-loop

| | |
|---|---|
| if j=i+1 | //i is lc(i+1) |
| if not exists(1c(i+1)) | |

if p(rightSTOP(i) | b) == 0: continue for-loop at j=i+2

| | |
|---|---|
| spannedByNext = p(rightSTOP(i) \| b) | |
| else | //j>i+1 |

if p(leftSTOP(i+1) | b) == 0: stop for-loop

for all possible roles r of token i

```
          compute p(r(i,j) | b) of dependency r between tokens i and j given b
          if p(r(i,j) | b) == 0: continue for-loop at next r
          p(r(i,j) | b) *= spannedByNext * p(leftSTOP(i+1) | b, r(i,j))
          if p(b) * p(r(i,j) | b) > p( last element of new_beam )
            insert b with r(i,j) into new_beam according to p(b) * p(r(i,j) | b)
...
```

1. A method of parsing natural language comprising the steps of:
a) receiving a tokenised and part-of-speech tagged utterance comprising n tokens
b) for the first token;
i) calculating a partial parse consisting of one dependency relation by assigning a role and a head for the first token;
ii) calculating the probability of the partial parse from step (i)
iii) repeating steps (b)(i) and (b)(ii) for all possible heads and roles of the token and storing the A most likely resulting partial parses
c) advancing to the next successive token and, for each of the A partial parses from the previous step:
i) calculating a possible next extension to the partial parse by one dependency relation
ii) calculating the probability of the extended partial parse from (c)(i)
iii) repeating steps (c)(i) and (c)(ii) for all possible heads and roles of the token and storing the A most likely resulting partial parses
d) repeating step (c) for each successive token until all n tokens have been parsed.

2. A method of parsing as claimed in claim 1 wherein each partial parsing calculation step includes checking that the possible dependency relation does not result in a dependency cycle.

3. A method of parsing as claimed in claim 1 wherein the information that is stored for each partial parse comprises the probability of the parse, the role of each token and the position of each token's head.

4. A method as claimed in claim 1 wherein only projective parses are calculated.

5. A method as claimed in claim 4 wherein the information that is stored for each partial parse comprises the probability of the parse, the role of each token, the position of each token's head and the distance to the leftmost left child of each token.

6. A method of parsing as claimed in claim 1 wherein steps (b)(ii) and (c)(ii) further include calculating left and right STOP child probabilities.

7. A data processing program for execution in a data processing system comprising software code portions for performing a method according to claim 1 when said program is run on said computer.

8. A computer program product stored on a computer usable medium, comprising computer readable program means for causing a computer to perform a method according to claim 1 when said program is run on said computer.

9. A system comprising means adapted for carrying out the steps of the method according to claim 1.
